(19) United States
(12) Patent Application Publication
(10) Pub. No.: US 2007/0037574 A1
(43) Pub. Date: Feb. 15, 2007

(54) Method and apparatus of a location-based network service for mutual social notification

(76) Inventors: Jonathan Libov, Bedford, NY (US); Fred Pratt, Bayport, NY (US)

Correspondence Address: FOX ROTHSCHILD LLP, 100 PARK AVENUE, SUITE 1500, NEW YORK, NY, 10017, US

(21) Appl. No.: 11/500,826

(22) Filed: Aug. 8, 2006

Related U.S. Application Data
(60) Provisional application No. 60/794,764, filed on Apr. 24, 2006.
(60) Provisional application No. 60/706,848, filed on Aug. 9, 2005.

(51) Int. Cl. H04Q 7/20

(52) U.S. Cl. 455/435.2

(57) ABSTRACT

A method and apparatus for a location-based network service and notification system in which registered users are notified of mutual social interest is presented. Users subscribed in a community register in a network location, either by selecting from a stored catalog of locations a fixed network that corresponds to their physical location or by the spontaneous creation of an ad-hoc network based upon users who are all in the same location, and, after the presence of all other users registered in the network location and select information is presented to the user, the user is allowed to select other of the registered users. Once such selection is accomplished, the user is notified if the selection is mutual.

### PRIOR PROVISIONAL PATENT APPLICATIONS

The present application claims the benefit of U.S. Provisional Application No. 60/706,848 filed Aug. 9, 2005, as well as the further benefit of U.S. Provisional Application No. 60/794,764 filed Apr. 24, 2006, both of which are hereby incorporated by reference.

### FIELD OF THE INVENTION

The present invention relates to a method and apparatus of creating a proximity network to facilitate a notification system between users of the network, and more particularly, to a method and apparatus of a location-based network service in which registered users are notified of mutual social interest.

### BACKGROUND OF THE INVENTION

There have been a number of recent ventures aimed at facilitating communication between users of mobile devices (e.g., cellular telephones, Personal Digital Assistants [PDA's], smart-phones, etc.) who are within each other's immediate physical proximity. For example, with MIT's Serendipity users create profiles for themselves and the people they would like to meet. They are then connected to proximate mobile users who fit their desired profile. Not only does the system identify the user with whom one has like interests but also facilitates further mobile communication. By way of further example, Bluetoothing allows proximate mobile users to send messages directly to one another. For instance, one mobile user can send a message to another mobile user across a café.

The mobile social matching/messaging services disclosed in the prior art, however, have three significant shortcomings: 1) the misalignment between proximity and location, 2) the range and bandwidth limits of peer-to-peer short-range radio-frequency (RF) technology (such as Bluetooth), and 3) the artifice of electronic communication. Each of these three shortcomings will thus be discussed in turn:

1) The misalignment between proximity and location. Currently, the limits of mobile technology constitute an obstacle to the creation of useful ad hoc proximity networks. One technology for determining the proximity of mobile users is GPS (global positioning system), which is already embedded within a large share of mobile devices. However, GPS does not efficiently provide proximity detection. Building a GPS proximity-based network requires a central server, or middleware, to compile and process the latitude and longitude coordinates of every user. With this data, the system could then generate proximity networks by grouping together users who are within some threshold radius of proximity. Problematically, however, that radius would almost certainly have to be of a static and consistent length; from a user's perspective, this would rarely align with the user's definition of his present location. A user in Madison Square Park, for example, might find a network extending 500 feet useful (where 500 feet is the radius of the user to the boundaries of the park). A user attending an office party overlooking the park would find a network extending only 100 feet (the radius of the user to the boundaries of the office) more appropriate. Yet because latitude and longitude are two-dimensional, a GPS-based system could not distinguish between users in the office party who are truly thirty feet away and users who are fifty floors below but only thirty feet away on the horizontal plane. In short, because the threshold radius that determines proximity would have to be defined beforehand, GPS-based proximity networks would be inefficient and largely ineffectual. This is not even to mention the limits and unreliability of GPS functionality indoors.

The inherent shortcomings of GPS have motivated the use of Bluetooth to drive proximity-based social matching/messaging systems (e.g., MIT's Serendipity). Whereas GPS requires substantial data compilation and processing to determine proximity, and does not function indoors, Bluetooth is able to detect proximate mobile devices directly, indoors and outdoors. Yet the range and bandwidth of Bluetooth technology on mobile devices remain obstacles to creating useful ad hoc proximity networks.

2) Range and bandwidth limitations of peer-to-peer short-range RF technology. As alluded to in the previous section, the range of RF technology (e.g., Bluetooth) is a significant obstacle to creating useful ad hoc proximity networks. The current range in optimum conditions is about 10 meters, but often reduced by interference with other ambient RF signals. Although there have been several viable products on the market utilizing Bluetooth, such as Mobiluck and Nokia Sensor, complaints about the range of Bluetooth (and hence the efficacy of these services) persist.

Services such as Mobiluck and Nokia Sensor function by exchanging information directly between mobile devices via a wireless Bluetooth connection. If, for example, two Mobiluck users were sitting on opposite benches in a park, they would be able to view each others' personal pages, communicate, and exchange information on a peer-to-peer basis. This is in contrast to a typical voice call, or even a Mobile IM (instant messaging) session, in which information is transferred indirectly from one user to another (i.e., from one mobile device, through the wireless infrastructure, to the other mobile device). The method of direct Bluetooth connection is necessary, despite its drawbacks (range and bandwidth limitations) because services like Mobiluck and Nokia Sensor demand constant interaction between users, and hence a reliable peer-to-peer connection between them.

3) Artifice of electronic communication. It is awkward and unnatural to send an electronic message (e-mail, text message, or otherwise) to someone who is in the same room as you, as in a number of social mobile services (e.g., Nokia Sensor, Bluetoothing, Mobiluck). In this light, proximity-based matching/messaging services may be viewed as supplementary to the normal course of social interaction. That is, they create alternatives to how people normally socially interact. In general, electronic communication (e.g., short messaging service [SMS], e-mail, instant-messaging, and even video conferencing) is far less intimate and exciting than face-to-face interaction. A system that abbreviates electronic communication as much as possible, and more rapidly facilitates face-to-face interaction, is conspicuously absent in the prior art but would represent a compelling alternative to current trends in mobile social services.

Thus, as can be seen, problems exist with facilitating of communications between proximate users at a local level and allowing for quick transition from such local electronic communication to face-to-face interaction.

### SUMMARY OF THE INVENTION

Accordingly, the present invention is directed to utilizing the existing wireless infrastructure and the internet to arrange a social notification system between users of mobile devices.

According to one method, system administrators manually catalog real-world locations within real geographic communities, and create electronic, or virtual, “Network Locations” for all of those locations. In correspondence with a central server via the existing wireless infrastructure, mobile users can enter a Network Location, view images of other users in that Network Location, and select users for the purpose of indicating social interest.

In the second method, proximate users are entered into a common, ad hoc Network Location automatically. This embodiment accomplishes automatic proximity detection via an embedded short-range radio frequency transceiver.

In both embodiments, notification only occurs when the interest is mutual; that is to say, two users have indicated interest in one another.

The present invention, including its features and advantages, will become more apparent from the following detailed description with reference to the accompanying drawings.

### BRIEF DESCRIPTION OF THE DRAWINGS

FIG. 1 is an illustration of a central server, according to an embodiment of the present invention.

FIG. 2 is an illustration of a schematic of various options available on the client side, according to an embodiment of the present invention.

FIG. 3 is an illustration of a schematic of various data transfer routes, according to an embodiment of the present invention.

FIG. 4 is an illustration of the community account subscription process, according to an embodiment of the present invention.

FIG. 5 is an illustration of a mobile device showing an instance of the Location Determination Task, according to an embodiment of the present invention.

FIG. 6 is an illustration of a mobile device showing a network location display, according to an embodiment of the present invention.

FIG. 7 is an illustration of a mobile device showing a mutuality notification, according to an embodiment of the present invention.

FIG. 8 is an illustration of a scheme of a community of various users and mobile devices, according to an embodiment of the present invention.

FIG. 9 is an illustration of a scheme of a community of various locations and users, according to an embodiment of the present invention.

FIG. 10 is an illustration of an ad hoc location creation and registration process, according to an embodiment of the present invention.

FIG. 11 is an illustration of a data position scheme for Network Generation Data Packets, according to an embodiment of the present invention.

FIG. 12 is an illustration of a data position scheme for Network Generation Data Packets in an Ad Hoc Network, according to an embodiment of the present invention.

FIG. 13 is an illustration of a data position scheme for User Selection Data Packets, according to an embodiment of the present invention.

FIG. 14 is an illustration of the methodology of a system user selection process, according to an embodiment of the present invention.

### DETAILED DESCRIPTION OF THE INVENTION

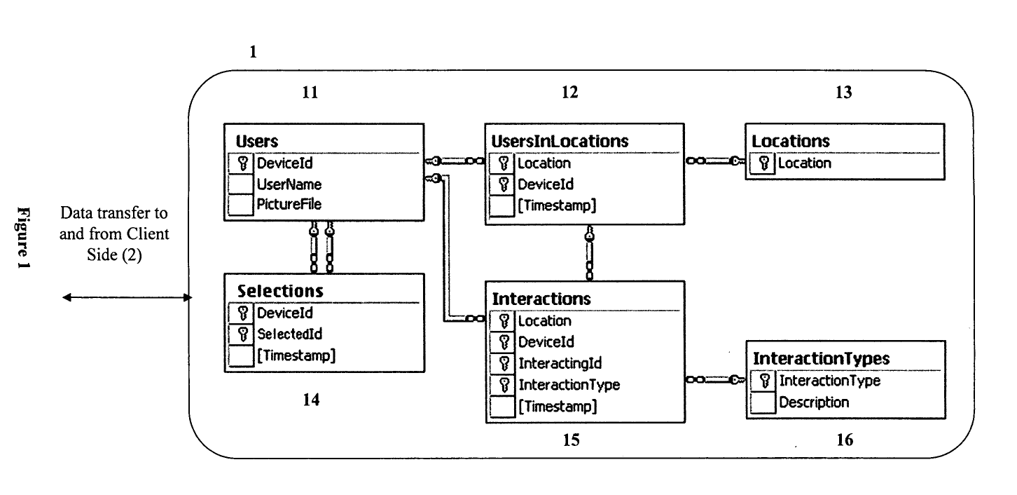

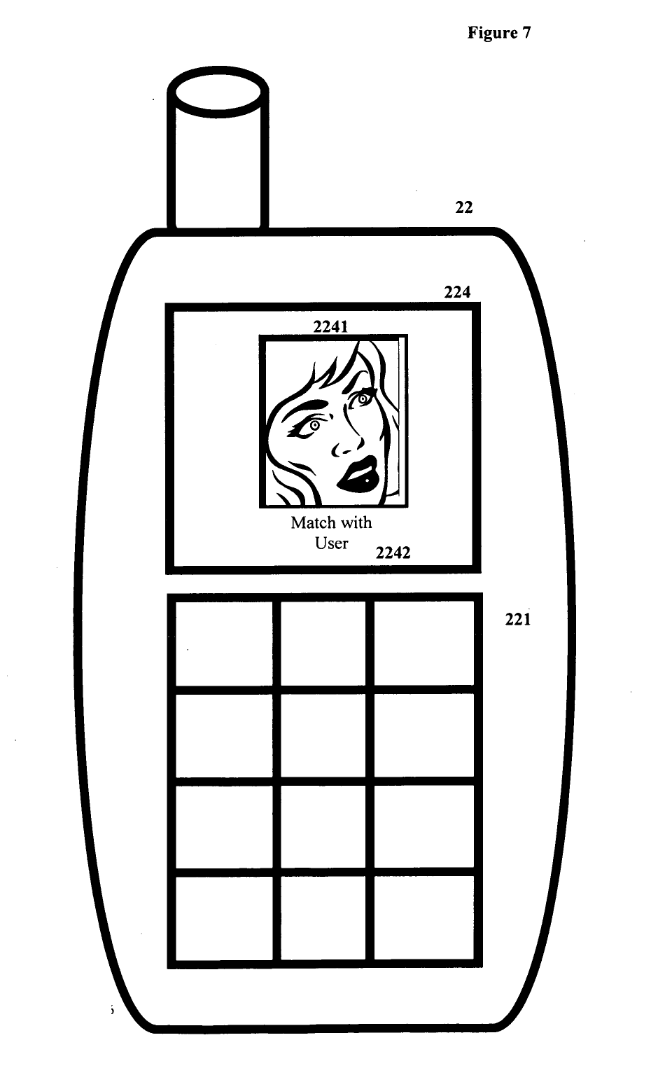

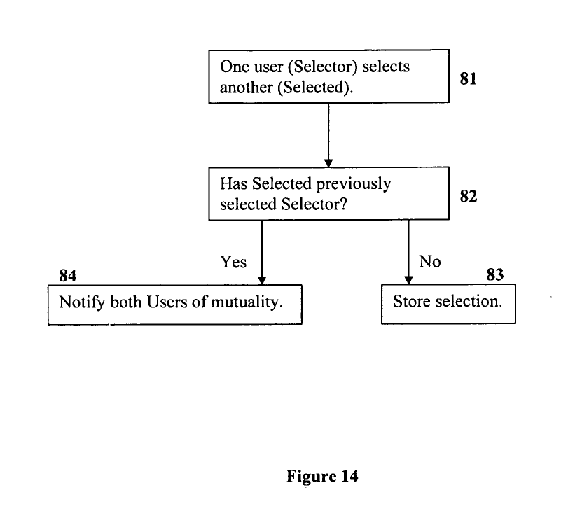

FIGS. 1 through 14 illustrate a method for creating proximity networks without utilizing Bluetooth, as well as a method for creating more effective and efficient Bluetooth proximity networks. It is to be understood, of course, that while there are a number and variety of possible implementations of the system, the preferred embodiment of the system is implemented using secure real-time transfer protocols (SRTP), which allow for encrypted information to be authenticated and transferred in real-time between user and system as well as within the system, and Structured Query Language (SQL) databases, which allow information to be created, stored, retrieved, transferred, defined, and manipulated to, from, between and within relational databases.

Referring now specifically to FIG. 1, the present invention is primarily embodied by a central server (CS) 1. It is to be understood, however, that the software/hardware components could be synthesized, segregated, or even distributed across multiple databases and servers without departing from the spirit or scope of the invention. For exemplary purposes only, the Microsoft SQL Server Desktop Engine (MSDE) database is depicted in the figure as part of the CS 1.

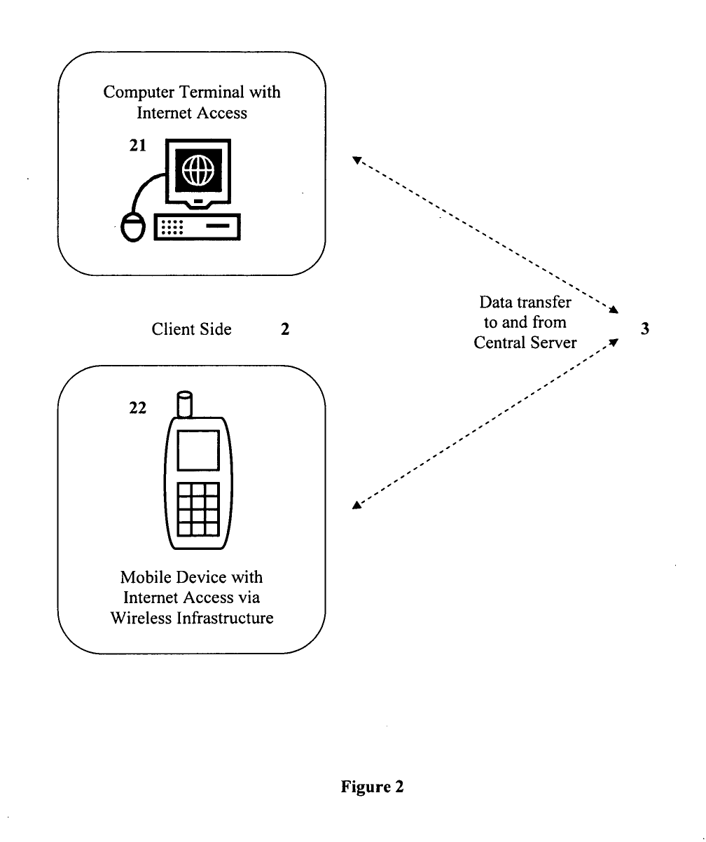

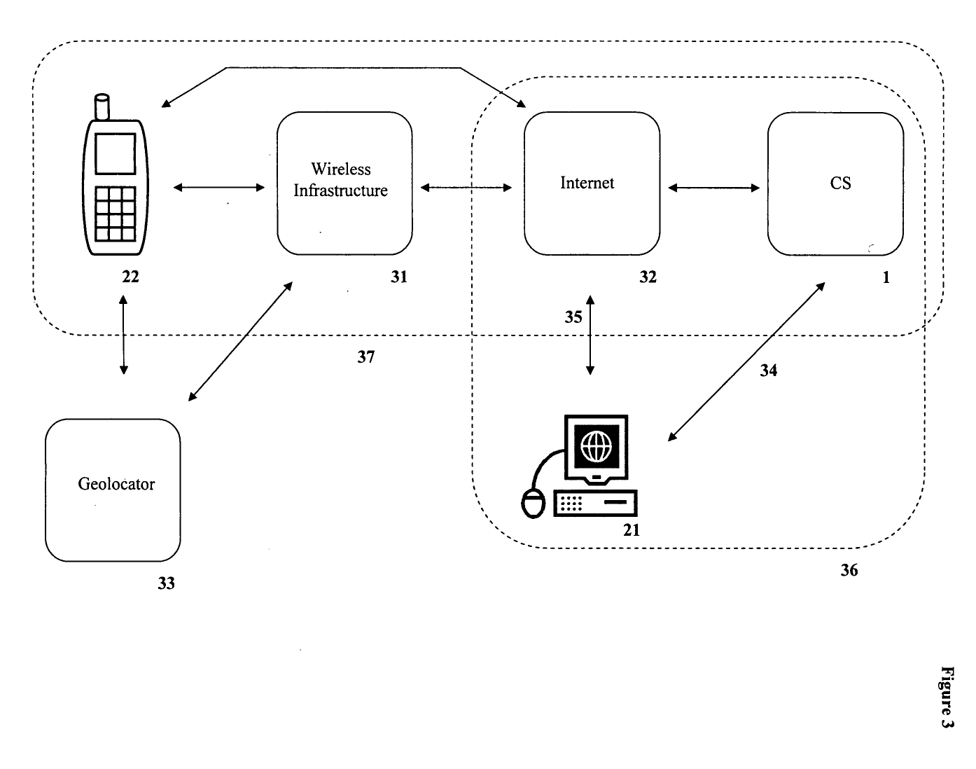

Referring now additionally to FIGS. 2 and 3, community accounts are registered either on a mobile device 22 (via the wireless infrastructure 31, possibly using Wireless Access Protocols (WAP), through the internet 32 to the CS 1, or more directly through wireless internet 32, likely using Wireless Internet Protocols (WIP), to the CS 1, collectively referred to as Mobile Access 37) or on a personal computer 21 (internet 32 via communication route 35 to CS 1, or directly via communication route 34 to CS 1, collectively referred to as Computer Access 36).

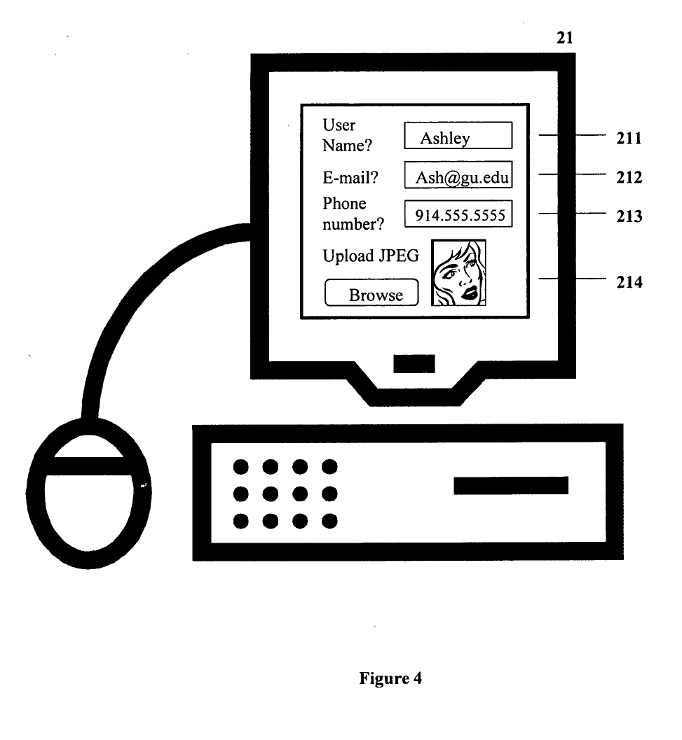

Referring now additionally to FIG. 4, minimally, a user must have a mobile telecommunications address 213 and a PictureFile 214 that resembles the user's current likeness, and both optionally, an e-mail address 212 and a username 211. This information is stored in a database on the CS 1, preferably being stored in the Users Database 11. Assuming that at least two users have set up accounts in one community, and at least two locations have been cataloged and set up as Network Locations, the system is ready for operation.

Accordingly, there are three primary tasks to be performed: 1) Location Determination, 2) Network Generation, and 3) User Selection. Each will be discussed in turn below:

1) Location Determination Task: One embodiment of the present system, referred to herein as the Fixed Network Location Method (and which provides a solution to the misalignment problem discussed above), enables de facto proximity networks based on user's selection of their location from a stored catalog of locations. Using this virtual grid of locations, users can situate themselves in an appropriate proximity network without the inaccuracy of GPS or the range limitations of Bluetooth or other RF technologies. Being virtually connected to all users within 30 feet on the horizontal plane, as with a GPS solution, may be useful, but certainly not as useful as being connected to all users within the same room, building, or other well-known and well-defined area (as in the present invention).

This embodiment of selecting locations has the added advantage of allowing users to specify a location at which they anticipate being in the near future. For example, a user walking from his dormitory to the gym could preemptively select “Gym” as his location, thereby assuring that he will appear as a member of that location immediately upon his arrival.

Another embodiment of the present system, referred to herein as the Ad Hoc Network Location Method (and which provides a solution to the Bluetooth problem discussed above), is to automatically enter all proximate users into a common virtual location via Bluetooth. In contrast to Mobiluck, Nokia Sensor, and other Bluetooth-enabled social mobile services, Bluetooth is utilized by the present system exclusively to discover the identity of users in the same geographic location. Recall that in Mobiluck and Nokia Sensor, Bluetooth is used to transfer information directly between mobile devices, necessitated by the demand for constant interaction between mobile users. The function of the present system does not require constant interaction between mobile users; therefore a reliable Bluetooth connection, with all its inherent shortcomings, is rendered superfluous.

This embodiment essentially corrals all the users in a populated geographic location into the same virtual network location. This ad hoc location more effectively represents a populated real-world location than any Bluetooth-enabled social mobile applications in the prior art. Put more succinctly, the prior art discloses systems for mobile social applications between users who are relatively proximate to one another, but the present system enables a mobile social application between all users who are all in the same location.

Each of these two embodiments under the Location Determination Task, that is a) the Fixed Network Location Embodiment and b) the Ad Hoc Network Location Embodiment, will be described further herein below:

a) Fixed Network Location Embodiment. The operation of the present implementation of the system begins with the identification of a “Location Community” where the system will be implemented. Here “Location Community” refers to a real-world set of locations, with relatively finite geographic boundaries, inhabited by a relatively finite population. A college or university, for example, would be an ideal Location Community for this embodiment of the present invention to be implemented.

“Fixed Location” here refers to any real-world place, building, outdoor expanse, etc. whose boundaries can be reasonably defined, and whose identity as a location persists over time. There may also be locations within locations, and locations within locations within locations, referred to herein as sub-locations. For example, a building would be a fixed location, while a room within the building would be a fixed sub-location. Each of these locations and sub-locations are represented within the system by a corresponding virtual location. In order to distinguish between real-world locations and the corresponding location within the system, the latter are referred to as “Network Locations.” For example, the virtual location that corresponds to the library would be referred to as the Library Network Location.

The catalog of Fixed Network Locations is entered by a system administrator and stored on a database on a central server, where the present implementation is primarily embodied. A system administrator is defined as any person who is authenticated (e.g., via password entry, electronic authentication, etc.) with the following privileges:
a. Add, change, delete or modify user information other than that which pertains to his/her user account; and
b. Add, change, delete or modify information in the catalog of Network Locations.

When the locations in a community have been cataloged, users can create Community Accounts. A Community Account is defined as a subscription with the central server of a unique user; the set of Network Locations that a user can enter varies according to which community a user has joined. Users must submit, at minimum, a picture of their current likeness, and their mobile telecommunications address, and optionally their name and/or a unique username.

Users are likely to join, and may even be restricted to, communities that are geographically relevant. Further, because the present system discloses a method of notification within real geographic communities, it is useful to verify that each user actually belongs to the real-world community he or she is attempting to join. The exclusivity of the community reinforces the communal aspect of the system. For instance, the Fixed Network Location Method is most preferably embodied at a college or university. Here the university would serve as the community, and the pool of users who may join this community would be said university's student body. In fact the pool of users may be restricted to the student body. Because this community is permanent, static, and persistent, the factor of limiting the Community Account to only those users who actually belong to the community provides one distinguishing element to the systems in the prior art.

One method for users to verify their membership in the community (re: joining a community and creating a community account) is to submit their personal e-mail address with a domain name associated with the community. For example, a student who enters “student@vassar.edu” can join the community limited to those users whose e-mail addresses share the same domain name, and who thus attend the same university (e.g., Vassar).

Accordingly, two methodologies (i and ii) for location determination within the Fixed Location Network Embodiment will be discussed below:

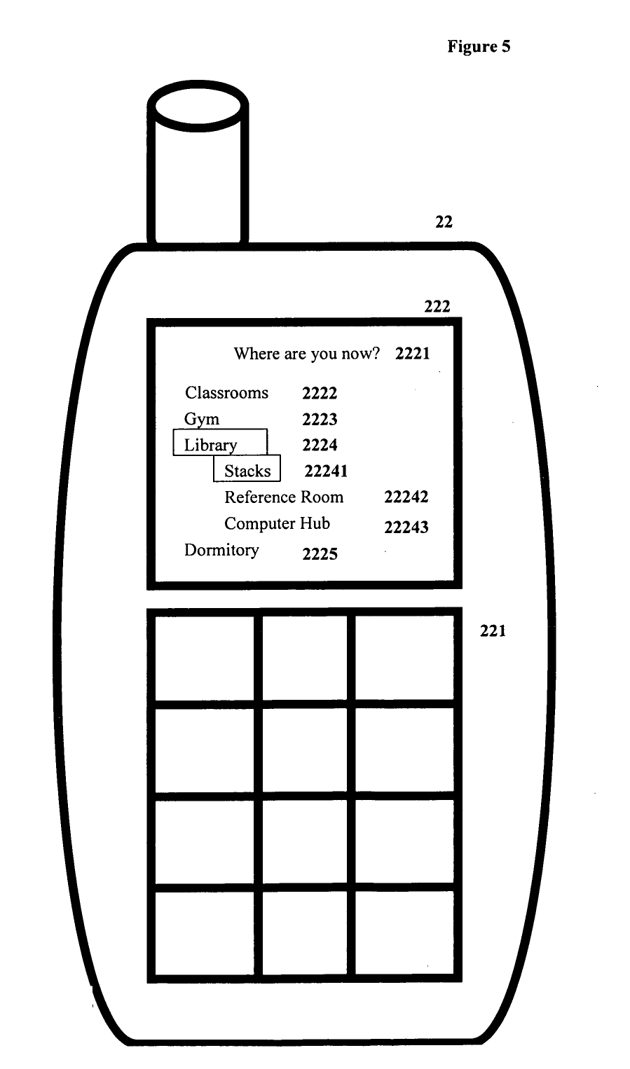

i. Location determination by Local Software: Referring now additionally to FIGS. 5, 6 and 7, upon user registration, a software program (herein the “Location Determination Software”) at least partly specific to the Community Account is downloaded (via Mobile Access 37) to the user's mobile device 22 from the CS 1. To select a Network Location, the user accesses the software. The user is then presented (on his or her mobile device's display) a concise list 222 of Network Locations 2222-2225. The user then scrolls to the Network Location that most accurately and specifically identifies his or her real geographic location, as described above. The user then selects that Network Location. If there are further Network Sublocations 22241-22243 within that Network Location 2224, then by virtue of selecting the Network Location the user is presented with a specific list of those Network Sublocations. The user selects the Network Sublocation that most accurately and specifically identifies his real geographic location. If none of the Network Sublocation identifies his real geographic location, or there are no available Network Sublocations to choose from, the user may simply select the more general Network Location.

Optionally, GPS last point of entry could be used to refine the choice of locations presented to a user upon accessing the Location Community. If GPS location information, acquired by a geolocator 33 likely embedded within the mobile device 22 transmitted to the CS 1 via Mobile Access 37 could be used to determine that a user's coordinates placed them within, or very near to, a particular real geographic location (e.g., the library), said user could be initially presented with a choice of only the associated sublocations within that Network Location (i.e., Library Network Location).

Also optionally, the Network Locations may be presented as a map in a graphical user interface. Selection of a Network Location and subsequent Network Locations in this case would be implemented by selecting (pressing the mobile keypad 221 or a stylus to the mobile screen), a visual representation of the Network Location on a spatially relative map.

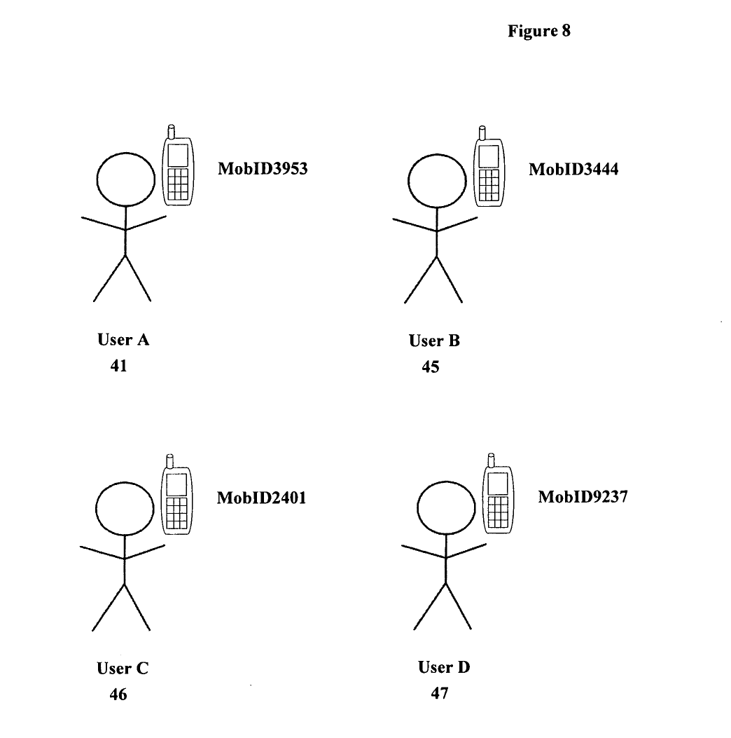

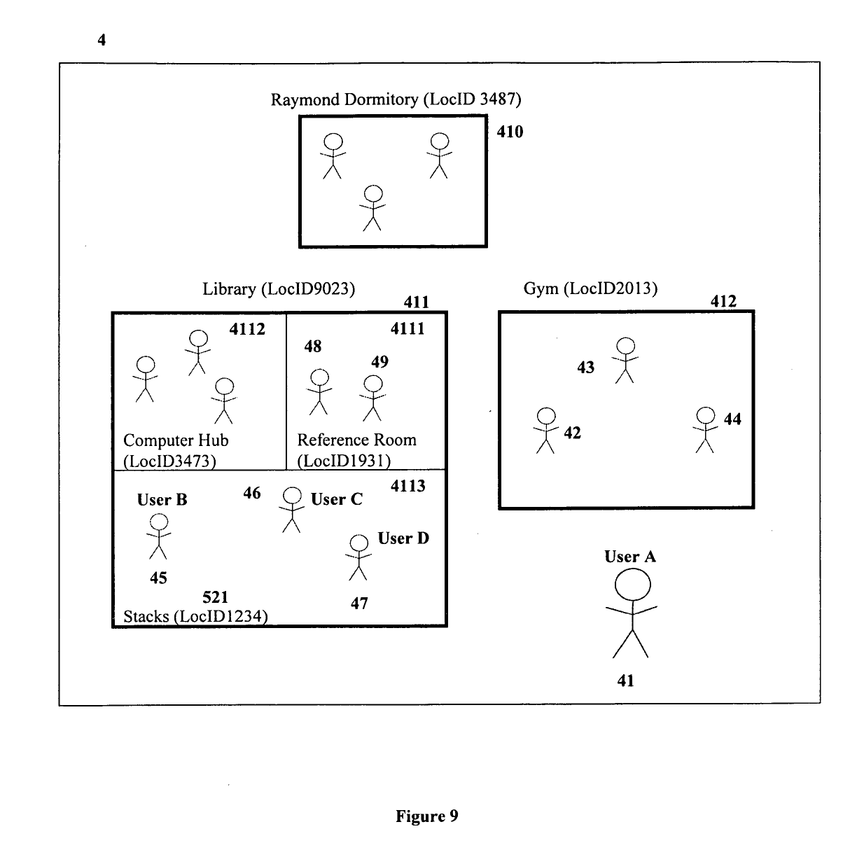

Referring now additionally to FIGS. 8 and 9, the following example illustrates the Fixed Network Location Method. User A 41 is walking to the Library 411. He enters the library, enters the room officially or commonly known as the “Stacks” 4113, and in order to initiate the present system, opens his mobile device 22 and accesses the Location Determination software 222. The Location Determination Software calls up a list of Network Locations 2222-2225, which are presented on the mobile device's display. User A can then scroll through this list until he finds “Library” (2224 the Network Location that most accurately describes his real geographic location). User A then selects the Library using his mobile keypad 221 or by pressing a stylus on the screen. If there are further Network Sub-locations 22241-22243, they will appear in a subsequent pull-down menu, expanded hierarchy, or on a new, refreshed screen. In similar fashion, User A selects a Network Sub-location, “Stacks” 22241. A user who is actively selecting and registering in a location is referred to herein as a “Registering User”.

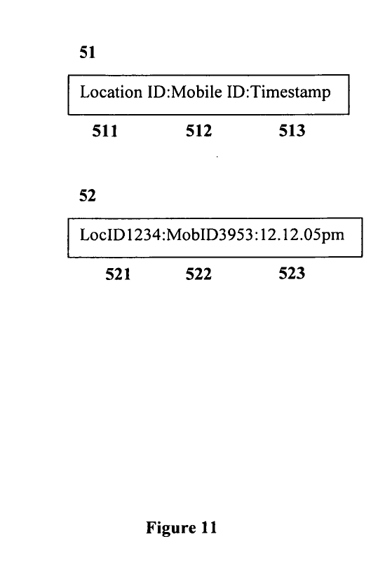

Referring now additionally to FIG. 11, the Location Determination software associates Location ID's (i.e., unique alphanumeric strings that are not necessarily human readable) with each Network Location. Upon the user selecting a Network Location, the software on the mobile device then calls up the Location ID 511 previously associated with the Network Location. The mobile device 22 then transfers the Location ID along with the user's Mobile ID 512 (e.g., telecommunications address, SIM card number, Mobile Identification Number, account number specific to the present system) of that mobile device and a timestamp 513 in a Network Generation Data Packet 51 via Mobile Access 37 to the UsersInLocation Database 12 of the CS 1. By means of his Mobile ID 512, a user is thereby registered in a Network Location.

Thus, when User A selects “Stacks”, the system calls up the Location ID 521 associated with “Stacks”, and sends it along with the unique Mobile ID 522 of that mobile device and a timestamp 523 in a Network Generation Data Packet 52 via Mobile Access 37 to the UsersInLocation Database 12 of the CS 1. User A, here a “Registering User” is thereby registered in the “Stacks” Network Location.

ii. Location determination implemented as a Mobile Webpage: Upon registration, the user is provided with a community-specific World-Wide-Web (WWW) address or Uniform Resource Locator (URL). The link to this address is either stored as a Favorite on the Mobile Device 22, or as a software program that automatically directs the Mobile Device's Web Browser to the address, or is presented so the user can save the address and manually enter it. The website may be accessed entirely through a Graphical User Interface, provided via Mobile Access 37 from the CS 1.

From the user's perspective, Location Determination via Mobile Webpage is indistinguishable, or nearly indistinguishable, to Location Determination via Local Software. One difference, which may well be hidden to the user by a graphical user interface, is that each Network Location may be implemented as a WWW address or URL, the selection of which calls up another webpage. Alternatively, a web-based application (e.g., a Java MIDlet) is downloaded, providing pull-down or hierarchical menus, eliminating the need for a webpage refresh. The process of selecting a location is the same, except that all information, including the graphical user interface is presented via a mobile webpage. Creation, implementation, and navigation of mobile web-pages are well known to those skilled in the art.

The section that immediately follows, the Ad Hoc Network Location Embodiment, discloses an alternative to the Fixed Network Location Embodiment.

b) Ad Hoc Network Location Embodiment. The Ad Hoc Network Location Embodiment additionally requires that users' mobile devices are equipped with short-range RF technology. RF technology allows physically separate electronic devices (e.g., personal computers, printers, mobile devices) to establish connections between one another wirelessly.

Many mobile devices on the market are currently equipped with Bluetooth, a member of the set of RF technologies. Other RF technologies include the IEEE 802.11 family of Wi-Fi standards, and Ultrawide-band technology. Because Bluetooth is the most pervasive RF technology on the wireless market, and was utilized to build a prototype of the present embodiment, Bluetooth is used here to enable Proximity Discovery, defined below. It is to be understood, however, that using RF protocols other than Bluetooth to enable Proximity Discovery would not depart from the spirit or scope of the disclosure of the present invention.

The present system utilizes Bluetooth not as a means for data transfer or communication, but merely as a proximity detector. The software comprising the present system enables Proximity Discovery, whether manually or automatically. When a “Founding User” (defined here as the first user in a location to initiate the system) initiates Proximity Discovery, his mobile device scans the proximity for other mobile devices subscribed to the same system. These devices belong to “Successive Users”, defined here as all proximate mobile users who are subscribed to the system and/or have initiated Proximity Discovery in temporal succession of the Founding User.

The mobile identification numbers, or Mobile ID's (e.g., the mobile device's SIM card number, mobile telecommunications address, unique system ID) of the Successive Users are acquired during Proximity Discovery, via Bluetooth, and stored temporarily on the Founding User's mobile device. Those Mobile ID's, as well as the Mobile ID of the Founding User, are then transferred via Mobile Access 37, optionally via the WWW, to the system's central server. The central server recognizes the user sending this information as a Founding User, and subsequently creates a new, spontaneous location in the system's database. This new, spontaneous location is referred to herein as an “Ad Hoc Network Location”.

All Successive Users will be recognized by the central server as such; hence, subsequent Proximity Discoveries by Successive Users will enter them into the previously created Ad Hoc Network Location. It must be reiterated that all subsequent data transfer occurs between each user and the central server, not between mobile users. This method allows for users who are in the same location as one another, but are outside a 10-meter (the optimum range of Bluetooth) proximity, to enter a common Network Location. In other words, users who are not in the same proximity, but are both proximate to a common, unique user (even by multiple degrees of separation), may enter the same Network Location.

The first step in automatically entering a Network Location via the Ad Hoc Network Location Embodiment is Proximity Discovery. After opening the system software, the software instructs the mobile device's Bluetooth component to detect other mobile devices in its proximity. Alternatively, the Proximity Discovery can be initiated manually by selecting an item in the software using the mobile keypad 221 or pressing a stylus to the device's display screen. Proximity Discovery may be repeated cyclically (e.g., once every five minutes) or initiated manually by the user.

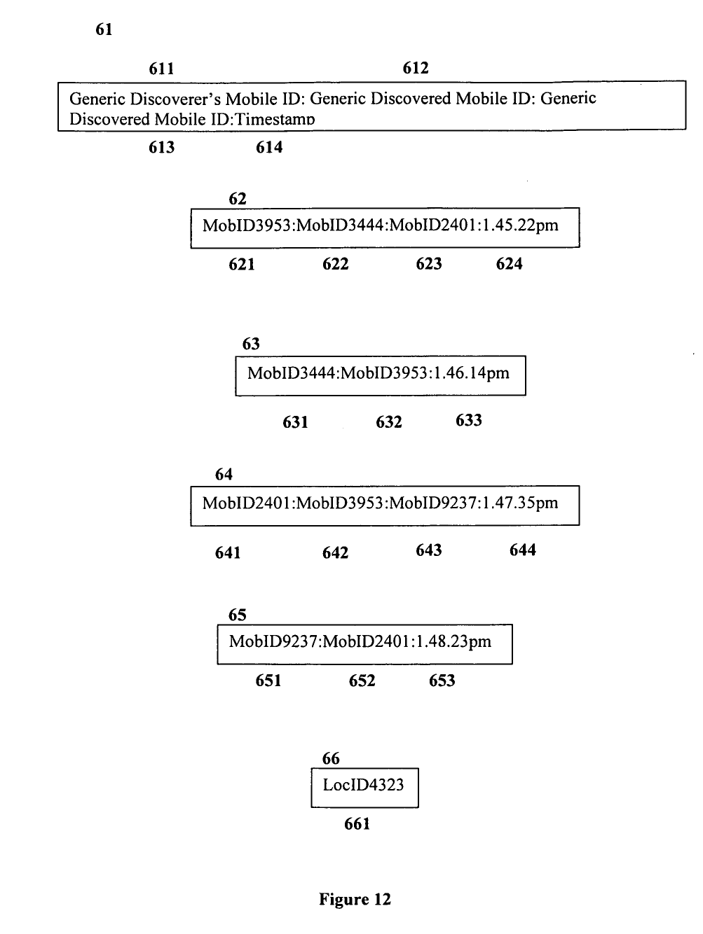

Referring now to FIG. 12, the Proximity Discovery acquires the Mobile ID's (referred to herein as Discovered Mobile ID's) of the mobile devices in its proximity, and stores them temporarily in the memory of the Discovering device. The Discoverer and Discovered's Mobile ID's (611 and 612-613, respectively) along with a timestamp 614 are sent in an Ad Hoc Network Generation Data Packet 61 via Mobile Access 37 to the CS 1. In this embodiment of the CS 1, the Ad Hoc Network Generation Data Packet 61 is first processed by the Users Database 11. Note that User Selection Data Packets may be stored indefinitely.

This Database 11 then queries the UsersInLocation Database 12 to determine if any of the Discovered Mobile ID's 612-613 have previously been registered in a Network Location. If not, a new Ad Hoc Network Location, in the form of a randomly generated alphanumeric string (e.g., a Globally Unique Identifier [GUID]), is created in the Locations Database 13. The user, which in this case is the Founding User, is then registered in said Ad Hoc Network Location (by registering the Discoverer's Mobile ID 611 in that Network Location in the UsersInLocation Database 12). If one or more of the Discovered Mobile ID's 612 and 613 has previously been registered in a Network Location (i.e., the user had not been a Founding User but rather a Successive User) the Discoverer is then registered in the Network Location of the Founding User. If two or more users have been registered in two or more Network Locations, the Discoverer is then registered in all of those Network Locations.

Alternatively, the CS 1 may also transfer the Ad Hoc Network Location ID 661 via Mobile Access 37 to the mobile device 22 associated with the newly registered Ad Hoc Network Location ID. Subsequently, all future Discoverers will acquire the Ad Hoc Network Location ID(s) 661, as opposed to the Mobile ID 712-713 of Discovered devices. Referring back now to FIG. 11, and similarly to the Fixed Network Location Method, the Discovering mobile device then transfers its own Mobile ID 512 and the Location ID 511 (acquired from the Discovered user) along with a timestamp 513 in a Network Generation Data Packet 51 via Mobile Access 37 to the CS 1. That system user is then registered in that Network Location according to methods described in the Fixed Entry Network Location method.

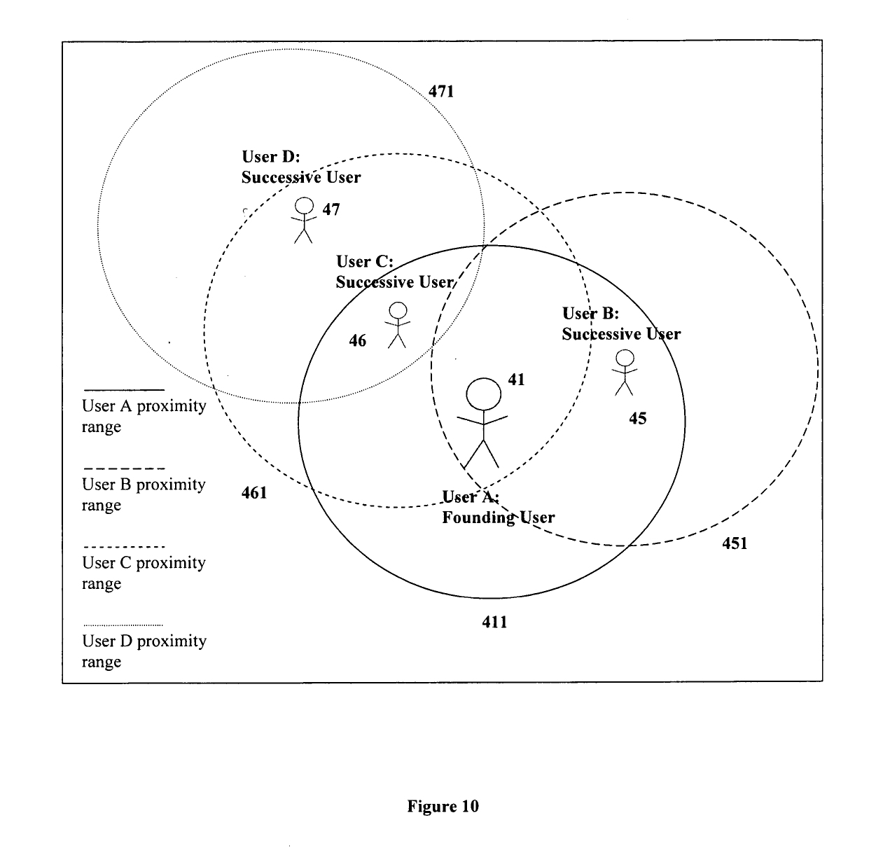

Referring now back to FIG. 10, the following example illustrates the methodology of the Ad Hoc Network Location Embodiment. User A 41 initiates a Proximity Discovery. Because he is within the proximity range 411 (optimally 10 meters if proximity detection technology is Bluetooth) of User B 45 and User C's 46 mobile devices, his mobile device 22 is able to acquire from their devices their respective Mobile ID's 622-623. Because he is not in proximity range 411 of User D 47, and thus cannot establish a Bluetooth connection, he cannot acquire the Mobile ID of User D 47. Note that Users B 45 and C's 46 mobile devices do not need to be actively running the system software for User A's mobile device 22 to acquire their Mobile ID's 622-623 during Proximity Discovery. Also, in this illustration, User A 41 represents the Founding User, because he is the first in the location to initiate a Proximity Discovery. Users B, C, and D 45-47 represent Successive Users, because they will initiate Proximity Discovery in subsequence of User A 41, the Founding User.

User A's Mobile ID 621, here the Discoverer's Mobile ID, and User B and C's Mobile ID's 622-623, here the Discovered ID's, along with a timestamp 624 are sent in an Ad Hoc Network Generation Data Packet 62 via Mobile Access 37 to the Users Database 11 of the CS 1. The Users Database 11 then queries the UsersInLocation Database 12 to determine if any of the Successive Users have previously been registered in a Network Location. Because none of the Mobile ID's 621-623 of Users A, B, and C have previously been registered in a Network Location, the Location Database 13 creates a new, spontaneous Ad Hoc Network Location in the form of a GUID. User A 41, by means of his Mobile ID 621 is registered in that Network Location in the UsersInLocation Database 12.

User B 45 is only in proximity range 451 of User A 41, so when User B initiates a Proximity Discovery he only acquires User A's Mobile ID 632. User B's Mobile ID 631, here the Discoverer's Mobile ID, and User A's Mobile ID 632, here the Discovered's Mobile ID, along with a timestamp 633 are transferred in an Ad Hoc Network Generation Data Packet 63 to the CS 1 via Mobile Access 37. Because the UsersInLocation Database 12 recognizes that User A's Mobile ID 632 has previously been registered in a Network Location, User B 45, by means of his Mobile ID 631 is also registered in that Network Location.

User C 46 is only in proximity range 461 of Users A 41 and D 47, so when User C 46 initiates a Proximity Discovery he only acquires User A 41 and User D's 47 Mobile ID's 642 and 643, respectively, here the Discovered Mobile ID's. These data, along with User C's Mobile ID 641, here the Discoverer's Mobile ID, and a timestamp 644 are transferred in a Network Generation Data Packet 6.4 to the CS 1 via Mobile Access 37. Because the UsersInLocation Database 12 recognizes that User A's Mobile ID 642 has previously been registered in a Network Location, User C 46, by virtue of his Mobile ID 641, is also registered in that Network Location.

User D 47 is only in proximity range 471 of User C 46, so when User D 47 initiates a Proximity Discovery he only acquires User C's 46 Mobile ID's 652, here the Discovered's Mobile ID. These data, along with User D's Mobile ID 651, here the Discoverer's Mobile ID and a timestamp 653 are transferred in a Network Generation Data Packet 65 to the CS 1 via Mobile Access 37. Because the UsersInLocation Database 12 recognizes that User C's Mobile ID 652 has previously been registered in a Network Location, User D 47, by virtue of his Mobile ID 751 is also registered in that Network Location.

Note that Users B 45, C 46 and D 47, are now registered in a common Ad Hoc Network Location, though neither Users C nor D are in proximity range of User B 461, 471, 451, respectively. Also note that Users A 41 and D 47, are now registered in a common Ad Hoc Network Location, though they are not in proximity range 411, 471, respectively, of each other.

Also note that the Founding User (in this example, User A 41) need not be a person or even a mobile device. It could be a static Bluetooth-enabled device with or without Mobile Access 37 or Internet Access 35. This “dummy” user could serve as a wireless beacon for a real-world geographic location, such as a bar or restaurant. A dedicated Bluetooth-enabled device would have the advantage of greater range and permanent battery power, in comparison to the capabilities of a mobile device 22.

Accordingly, while these embodiments of the Location Determination Task are by no means mutually exclusive, and may in fact be implemented simultaneously, it is important to convey that an objective of both the Fixed Network Location Embodiment and the Ad Hoc Network Location Embodiment is to enter users in common real-world locations (alternatively, “proximate users”) into common Network Locations. Because the Network Location is electronic, or virtual, new methods of social interaction are made possible. Entering proximate mobile users into common Network Locations merely makes possible the Mutual Notification Method, disclosed further below.

Having completed the Location Determination Task, the system turns to the second task, the Network Generation Task, as discussed below:

2) Network Generation Task: The Network Generation Task consists of delivering previously stored PictureFiles of system users in a common Network Location to a user who has just registered in that Network Location. Registration in a Network Location is accomplished by either the Fixed Network Location or Ad Hoc Network Location embodiments described above.

When a user has been registered in a Network Location (via his Mobile ID in the UsersInLocation Database 12 of the CS 1), the UsersInLocation Database 12 compiles all the Mobile ID's that have also registered in that Network Location. This compilation of Mobile ID's is then queried in the Interactions Database 15, which compiles the previously stored PictureFiles 2231-2233 associated with those Mobile ID's. In parallel, and only with respect to the Ad Hoc Network Location Embodiment, the Mobile ID's acquired during Location Determination are queried in the Users Database 11, which compiles all of the PictureFiles associated with those Mobile ID's. All of the PictureFiles that have been compiled, along with the corresponding Mobile ID's, are then sent via Mobile Access 37 to each user and displayed on his mobile device. The group of PictureFiles and Mobile ID's constitutes the Network Roster 223.

Note that the system is engineered such that the Network Roster never includes the PictureFile of the Registering User. Also note that Mobile ID's are hidden from view when the PictureFiles are displayed in human readable format on the mobile device, but the association between PictureFile and Mobile ID is maintained.

The exception to this method is when the Registering User (i.e., a user who is actively registering in a Network Location) is also a Founding User, which, according to the Ad Hoc Network Location Embodiment, entails that the user is the first in a geographic location to perform a Proximity Discovery. In this case, it is unnecessary for the UsersInLocation Database to compile all the Mobile ID's that have also been registered in a Network Location.

Referring again to FIGS. 10, 11 and 12, and for the sake of continuity and clarity, the following illustration of the Network Generation Task includes an abbreviated illustration of the Location Determination task. The Ad Hoc Network Location Embodiment is utilized in this illustration, though the Network Generation Task as described below would be nearly identical if the Fixed Network Location Embodiment had been utilized in its place. Any possible deviations do not significantly impact the integrity of the Network Generation Task. In addition, while this illustration is presented in a specific chronological order that best illustrates the present system, it is to be understood though that the functionality of the present system is by no means dependent on this particular sequence or chronology.

User A 41, here a Discovering, Founding, and Registering User, performs a Proximity Discovery. He acquires User B and User C's Mobile ID's 622 and 623, respectively, and these data, along with a timestamp 624 are transferred to the CS 1 in an Ad Hoc Network Generation Data Packet 62. The Mobile ID's 622-623 transferred in the Ad Hoc Network Generation Data Packet 62 are queried in the Interactions Database 15, where the associated PictureFiles 2231-2233 are compiled. This compilation of PictureFiles 2231-2233, along with the corresponding Mobile ID's, is the Network Roster 223, and it is transferred in its entirety to User A's mobile device, where it is displayed. User A 41 now views PictureFiles 2231-2233 of Users B and C 45 and 46, respectively on his mobile device 22.

User C 46, here a Discovering and Registering User, then performs a Proximity Discovery. He acquires User A and D's Mobile ID's 642 and 643, respectively, and these data along with a timestamp 644 are transferred to the CS 1 in an Ad Hoc Network Generation Data Packet 64. The UsersInLocation Database 12 recognizes that User A 41 has previously registered in a Network Location. User C is then registered in that Network Location (according to the Location Determination task). The UsersInLocation Database 12 compiles all the Mobile ID's registered in that Network Location (thus far only the Mobile ID belonging to User A). In turn, the Interaction Database queries the Interactions Database 15 to compile all the PictureFiles associated with those Mobile ID's. In parallel, User D's Mobile ID 643 is queried in the Interactions Database 15 via the UsersInLocation Database 12, and User D's PictureFile is included in the cumulative Network Roster. This Network Roster 223, including the corresponding PictureFiles and Mobile ID's of Users A and D, is then transferred to User C's mobile device, where it is displayed.

User D 47, here a Discovering and Registering User, performs a Proximity Discovery. He acquires User C's Mobile ID's 662, and these data are transferred with a timestamp 653 to the CS 1 in an Ad Hoc Network Generation Data Packet 65. The UsersInLocation Database 12 recognizes that User C 46 has previously registered in a Network Location. User D is then registered in that Network Location (according to the Location Determination task). The UsersInLocation Database 12 then compiles all the Mobile ID's registered in that Network Location (thus far the Mobile ID's of Users A and C. In turn, the UsersInLocation Database 12 queries the Interaction Database 15 to compile all the PictureFiles associated with those Mobile ID's. This Network Roster 223, including the corresponding PictureFiles and Mobile ID's of Users A and C, is then transferred to User C's mobile device, where it is displayed.

User B 45, here a Discovering and Registering User, performs a Proximity Discovery. He acquires User A's Mobile ID's 632, and these data are transferred to the CS 1 in an Ad Hoc Network Generation Data Packet 63. The UsersInLocation Database 12 recognizes that User A 41 has previously registered in a Network Location. User B is then registered in that Network Location (according to the Location Determination task). The UsersInLocation Database 12 then compiles all the Mobile ID's registered in that Network Location (thus far the Mobile ID's of Users A, C, and D 41, 46, and 47, respectively). In turn, the UsersInLocation Database 12 queries the Interactions Database 15 to compile all the PictureFiles associated with those Mobile ID's. This Network Roster 223, including the corresponding PictureFiles and Mobile ID's of Users A, C, and D, is then transferred to User B's mobile device, where it is displayed.

The preferred embodiment of the present system may include three features specific to the process of the Network Generation Task, that is, a) Location Deregistration, b) Automatic Refresh, and c) Expedited Registration.

a) Location Deregistration feature: The Location Deregistration feature de-registers a user from a Network Location after a fixed period of time (e.g., 3 hours), previously determined by the system administrator. This effectively logs each user out of a Network Location, such that users do not persist in Network Locations indefinitely. Users may also deregister from a Network Location manually. With respect to the Ad Hoc Network Location Method, this would be useful if a user moves from one venue (e.g., a café) to another (e.g., a restaurant). In this instance it would be inefficient for the User to still be registered in the Café Network Location, and hence to include other users registered in the Café Network Location in the Network Roster (which would also include users registered in the Restaurant Network Location. Rather, the user can manually deregister from the Café Network Location and re-register (whether as a Founding or Successive User) in the Restaurant Location.

b) Automatic Refresh feature: By setting a User Account to Automatic Refresh, whether on a user's mobile device 22 via Mobile Access 37 or on a personal computer 21 via Computer Access 36 to the CS 1, the Network Generation Data Packet 51 is resent automatically (according to the Network Generation process described above) at fixed time periods (e.g., five minutes). This effectively updates the Network Roster 223, such that it automatically includes users whose first Network Generation Data Packet was sent in temporal succession. For example, User B 45 registers in the “Stacks” Network Location at 9:30 am, and has set his Automatic Refresh to 10 minutes. User A 41 enters the Network Location “Stacks” at 9:35 am, and thus User B appears on User A's Network Roster 223 but not vice versa. After User B automatically refreshes at 9:40 am, his mobile device is sent a Network Roster that includes all users who have entered the “Stacks” in the three hours (see Location Time Out feature) prior to 9:40 am. This Network Roster will thus include User A.

Note that Automatic Refresh is only relevant to the Fixed Network Location Embodiment. An analogous process is accomplished in the Ad Hoc Network Location Embodiment by setting Proximity Discovery to some cyclical, or repetitive, schedule.

c) Expedited Registration feature: In some instances, and with respect to the Ad Hoc Network Location Method, it may be more expeditious for all Discovered Users to be registered in a Network Location by the Discovering User. This would allow the Discovered Users to be registered in a Network Location (and hence to download the Network Roster) prior to performing a Proximity Discovery of their own. For example, according to the Ad Hoc Network Location Method User A 41 is a Founding User, and in his Proximity Discovery discovers User B 45. User A transfers an Ad Hoc Network Generation packet containing his own Mobile ID and the Mobile ID of User B to the CS 1. In contrast to the description of the Ad Hoc Network Location method above (where only User A is registered in a new Ad Hoc Network Location, both User A and User B are registered in the new Ad Hoc Network Location simultaneously. Also in contrast to the description of the Ad Hoc Network Location method above (where User B discovers User A and then registers in the Network Location where User A is registered), User B first queries the CS to determine if he is already registered in a Network Location. In this example, and according to the Expedited Registration feature, User B is already registered in the same Network Location as User A. That Network Roster (which includes User A) is then transferred to User B. Subsequently, or perhaps simultaneously, User B performs a Proximity Discovery, and continues with the Ad Hoc Network Location method as described above. User B's Proximity Discovery in this instance is still necessary because User B may be in proximity of users which User A is not.

Having completed the tasks of Location Determination and Network Generation, and as the present invention relates to a notification system between mobile users, a solution to the artifice of electronic communication problem described above, referred to herein as Mutual Notification, is now described.

3) User Selection Task—Mutual Notification: The User Selection Task consists of users (herein the “Selectors”) selecting other (herein the “Selected”) users (identified by images on their mobile device) in whom they have a social interest. The end-result is that users are notified of this interest, but only when the selections are mutual.

As communication in the system described herein thus far is restricted to a mere notification, and because the meaning of the notification has already been defined (a mutual social interest) and the occurrence of the such notification immediately imparts a desire to meet, or talk, face-to-face, the present invention is best utilized by users visually identifying other users in their real, geographic location with whom they have a social interest, then using the present invention to submit their interest. The first step after visually identifying a person of social interest is registering in the Network Location corresponding to the user's real, geographic location. If initiated by the Fixed Network Location Method, a user will select the Network Location that best aligns with his real, geographic location. If initiated by the Ad Hoc Network Location Method, a user will register in an Ad Hoc Network Location automatically.

Once users have selected and/or logged into the appropriate Network Location, they are given access to an interactive “Network Roster”. A Network Roster contains distinguishing information for all proximate users (users who have selected the same “Network Location”). This information will contain, at minimum, an image, but will be sufficient to allow users to match the image displayed on their mobile device with the real-world likeness of the users who were previously visually identified.

Unlike other systems that utilize proximity networks to enable electronic communication (e.g., text messages, e-mails) between proximate mobile users, the present invention is unique in that it does not serve as a prelude to any form of mobile-based communication. Rather, it facilitates face-to-face, real world communication.

When a user (herein the “Selector”) has a social interest in another user (herein the “Selected”), the former finds and selects the image of the latter on the Network Location Roster. The Selection is transferred to the system's central server, where it is stored. Nothing occurs on either user's mobile device at this point. Notification only occurs when selections are mutual. That is, without being informed of each other's selections, the two users have selected one another. This notification is impersonal, and may not be authored or modified by either user.

The central server compiles all selections and strictly notifies users when mutuality has occurred. There are few important features of the notification process to note:
a. Users are not provided with each other's contact information (e.g., telecommunications address, e-mail address, etc.), with which to carry on further telecommunications.
b. Selections are stored indefinitely.
c. Selections may be removed or deleted at any time.

The following example illustrates a typical use of the present invention, but in no way represents the only possible use or implementation of the mutuality-contingent notification system disclosed here. The present system is described from the user's perspective:

User A walks into a café with some of his friends. He notices an attractive woman at the other end of the café. User A makes eye contact with the woman and she smiles back. User A, like many people, is insecure in these situations. Was her smile a signal? Is she interested or just being polite? How can he be sure the woman was looking at him and not one of his friends?

User A opens his phone, accesses the software program partly embodying the present invention, and selects the bar as his location. He then accesses the Network Roster and views images of proximate users (other users in the café) through the provided graphical user interface. He finds the image of a woman (User B) he is interested in, selects her (clicks on her picture), and puts his phone back in his pocket.

Although User A has indicated his social interest in User B by selecting her image, nothing occurs on either user's mobile device (from the end-users' perspectives).

It happens that the woman, User B, has a similar social interest in User A, but because of similar reservations she doe not want to approach him. User B accesses the software program on her mobile device and selects User A from the Network Roster. Within seconds of User B's selection of User A, both of their phones vibrate. They both see pictures of one another and a notification message (e.g., “Match”). Because they are now informed of their mutual interest, they can approach each other with confidence.

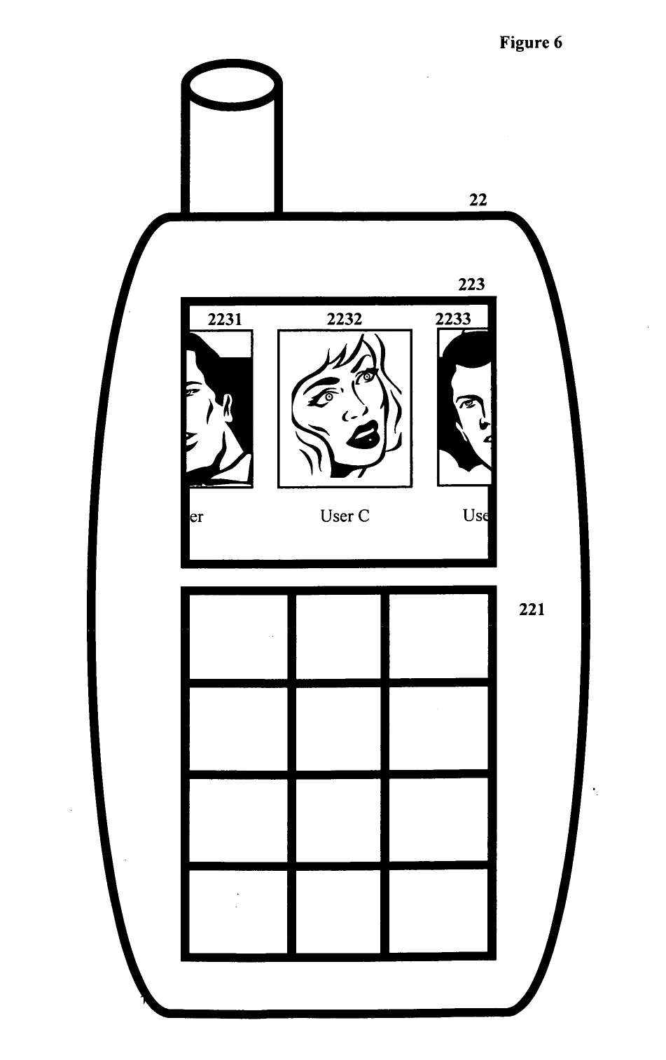

Referring back now to FIG. 6, when a user has a Network Roster 223 displayed on his mobile device 22, he has the option of selecting any of these users. Selection occurs by pressing a designated key on the mobile device's keypad 221 while the PictureFile 2232 of the identified user (here the Selected) is highlighted. Selection can also occur by pressing on the user's image on the mobile display with a stylus, or in a number of other fashions without departing from the spirit or scope of the present invention. Because the PictureFiles and Mobile ID's maintain their association when they are downloaded as a Network Roster 223, selecting a PictureFile allows the mobile device 22 to determine the Mobile ID of users that are to be selected.

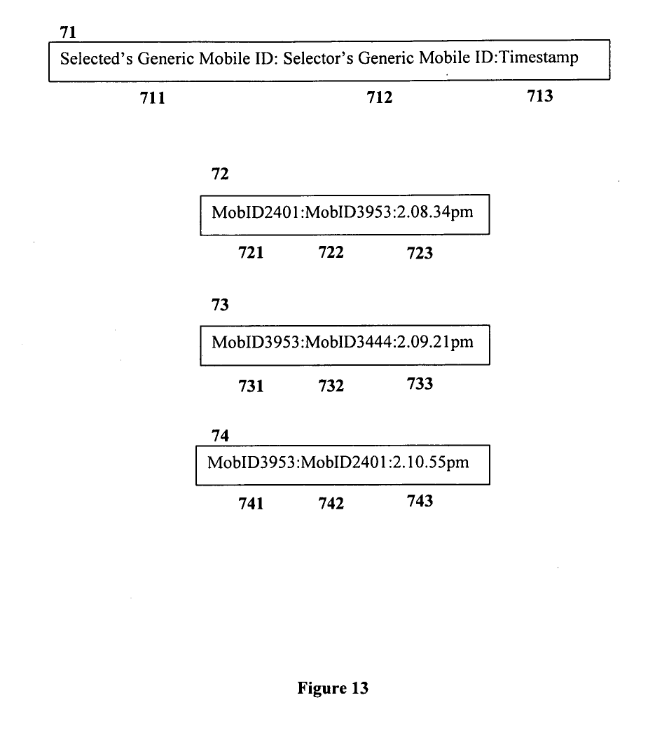

Referring now to FIG. 13, after a Selector identifies and selects a user (here the Selected User), the Selector's mobile device sends a User Selection Data Packet 71 to the CS 1 via Mobile Access 37. This User Selection Data Packet 71 minimally contains two items of data: the Selected's Mobile ID 721 and the Selector's Mobile ID 712. The User Selection Data Packet 71 is transferred to the CS 1, is first processed in the Selections Database 14. It is then queried in the Interactions Database 15 and stored in the Selections Database 14. A “Match” is made if the Selections and Interaction Databases 14 and 15, respectively find a matching (technically an opposite) User Selection Data Packet 71—entailing that the current Selector has already been selected by the Selected. Subsequently, both users (both of whom now fulfill the criteria of “Selector” and “Selected”) are simultaneously sent a notification 224 via Mobile Access 37 notifying them of the Match. In the preferred embodiment of the present system, this notification process is integrated into the Graphical User Interface of the present system (i.e., programmed into the Local Software). If not, it may also be sent in the form of a Short, Premium, Multimedia or Enhanced Messaging Service (SMS, PMS, MMS, and EMS, respectively) or e-mail. Alternatively, users' devices are directed to a webpage containing the notification of a match. All notifications minimally include a PictureFile 2241 of the matched user, and optionally a username 2242.

The following example illustrates the User Selection process. If User A has selected “Stacks” 4113 as his Network Location (the Location Determination task), and the Network Generation task is subsequently carried out, User A's Network Roster 223 will include Users B 45, C 46, and D 47. If User A 41 has a social interest in User C 46, User A (the Selector) will select User C's (the Selected's) PictureFile 2232 from the Network Roster. User C's Mobile ID 721 is derived from the selection of User C's PictureFile 2252, and a User Selection Data Packet 621 minimally containing User C's Mobile ID 721 and User A's Mobile ID 622 is then transferred by User A's mobile device to the CS 1, where it is processed and stored in the Selections and Interactions Databases 14 and 15, respectively.

If User C has a social interest in User A, he or she will also select User A's PictureFile from his or her own Network Location Roster. User C's Mobile ID 641 is derived from the selection of User C's PictureFile, and User C's device sends a User Selection Data Packet 64 containing User A's (now the Selected's) Mobile ID 641 and User C's (now the Selector's) Mobile ID 642 to the CS 1, where it is stored in the Selections Database 14. The Selections and Interactions Databases 14 and 15, respectively subsequently recognize the mutuality of the User Selection Data Packets sent by Users A and C 621 and 623, respectively. User A is then sent a notification 224 minimally containing a picture 2241 of User C and optionally User C's username 2242. User C is then sent a notification 226 minimally containing a picture of User A and optionally User A's username. See Drawing 14 for a basic procedural illustration of what occurs when a selection is mutual 81, 82, and 84.

Note how a lack of mutuality would not result in a notification within the current system. If User B 45 selected User A 41, User B's mobile device would send a User Selection Data Packet 63 minimally containing User A's (here the Selected's) Mobile ID 631 and User B's (here the Selector's) Mobile ID 632. No mutuality will be recognized as the result of this User Selection Data Packet 63 (precisely because User A has not previously selected User B). See Drawing 11 for a basic illustration of what occurs when a selection is not mutual 81, 82, and 83.

Thus as can be seen from the above description, the present invention facilitates notification of mutual social interest within a community of mobile users. By entering an electronic, or virtual, Network Location, proximate users can deliver a notification of social interest that would otherwise be impossible to implement in the real-world social realm. Notification of interest is only delivered when both users have selected one another; selections are processed and notifications are delivered securely and in real-time.

In the foregoing description, the method and apparatus of the present invention have been described with reference to specific examples. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. A method of creating a network to facilitate communication as between users of the network, the method comprising the steps of:
providing for selection of a network location;
registering the user in the network location;
informing the user registered in the network location of the presence of all other registered users in the network location;
allowing the registered user to select other registered users; and
notifying the selecting registered user if the selection is mutual.

2. The method according to claim 1, further comprising the step of:
cataloguing, in a database, the network locations such that they correspond to geographical locations.

3. The method according to claim 1, further comprising the step of:
establishing a community account allowing for use of the network.

4. The method according to claim 3, wherein the step of establishing a community account allowing for use of the network further comprises at least one of the steps of:
defining a community of network users; and
subscribing network users within a community.

5. The method according to claim 1, further comprising the step of:
verifying a user for membership in a community of the network.

6. The method according to claim 1, further comprising the step of:
loading network location determinative software on a user's mobile communication device.

7. The method according to claim 1, wherein the step of providing for selection of a network location further comprises at least one of the steps of:
manual entry of the network location that most accurately corresponds to the user's geographical location;
utilizing a GPS coordinate to assist in the selecting of the network location; and
utilizing a map illustrating geographical locations to assist in the selecting of the network location.

8. The method according to claim 1, wherein the step of registering the user in the network location further comprises at least one of the steps of:
communicating a location ID corresponding to the network location to a database,
communicating a mobile ID corresponding to a mobile communication device to a database; and
communicating a time stamp corresponding to the time of transfer to a database.

9. The method according to claim 1, further comprising the step of:
assigning a location ID with the network location.

10. The method according to claim 1, wherein the step of informing the user registered in the network location of the presence of all other users registered in the network location further comprises at least one of the steps of:
compiling the presence of all users registered in the network location into a network roster; and
communicating a network roster to the users registered in the network location.

11. The method according to claim 10, wherein the network roster includes information about the users registered in the network location.

12. The method according to claim 1, further comprising the step of:
deregistering a registered user from a network location on the basis of predetermined criteria or user-initiated deregistration.

13. The method according to claim 1, further comprising at least one of the steps of:
refreshing a network roster by re-registering the user in the network location; and
refreshing a network roster by re-informing the user registered in the network location of the presence of all other users registered in the network location.

14. The method according to claim 1, further comprising the step of:
storing the selection by the registered user of another registered user.

15. The method according to claim 1, further comprising the step of:
determining whether the selection by the registered user of another registered user is mutual.

16. The method according to claim 14, wherein the stored selections may be stored indefinitely or may be removed or deleted at any time.

17. The method according to claim 1, wherein the users of the network may access the network via at least one of a mobile communication device, a desk-top computer, and a laptop computer.

18. The method according to claim 1, wherein the network is resident on a central server.

19. The method according to claim 18, wherein the central server utilizes relational databases.

20. A method of creating a proximity network to facilitate communication as between users of the network, the method comprising the steps of:
detecting if there are users in a proximate location;
registering at least one of the users in the proximate location;
informing the at least one registered user in the proximate location of the presence of all other registered users in the proximate location;
allowing the registered user to select other registered users; and
notifying the selecting registered user if the selection is mutual.

21. The method according to claim 20, wherein the step of discovering if there are users in proximate location comprises at least one of the steps of:
initiating a scan of the proximate location for users; and
storing information regarding users in the proximate location.

22. The method according to claim 20, wherein the proximate location corresponds to a network location.

23. The method according to claim 20, wherein the step of registering at least one of the users in the network location further comprises at least one of the steps of:
communicating a location ID corresponding to the network location to a database,
communicating a mobile ID corresponding to a mobile communication device to a database; and
communicating a time stamp corresponding to the time of transfer to a database.

24. The method according to claim 20, further comprising the step of:
creating an ad hoc network location corresponding to the proximate location.

25. The method according to claim 20, further comprising the step of:
assigning a location ID to a newly created ad hoc network location.

26. The method according to claim 24, further comprising the step of:
registering in the ad hoc network location at least one user within a communication distance of a registered user in the proximate location.

27. The method according to claim 20, wherein the step of informing the registered user in the proximate location of the presence of all other registered users in the proximate location further comprises at least one of the steps of:
compiling the presence of all users registered in the proximate location into a network roster; and
communicating a network roster to the users registered in the proximate location.

28. The method according to claim 27, wherein the network roster includes information about the users registered in the proximate location.

29. The method according to claim 20, further comprising the step of:
un-registering a registered user from a proximate location on the basis of predetermined criteria.

30. The method according to claim 20, further comprising at least one of the steps of:
refreshing a network roster by re-registering the user in the proximate location; and
refreshing a network roster by re-informing the user registered in the proximate location of the presence of all other users registered in the proximate location.

31. The method according to claim 20, further comprising the step of:
storing the selection by the registered user of another registered user.

32. The method according to claim 20, further comprising the step of:
determining whether the selection by the registered user of another registered user is mutual.

33. The method according to claim 31, wherein the stored selections may be stored indefinitely or may be removed or deleted at any time.

34. The method according to claim 20, wherein the users of the network may access the network via at least one of a mobile communication device, a desk-top computer, and a laptop computer.

35. The method according to claim 20, wherein the network is resident on a central server.

36. The method according to claim 35, wherein the central server utilizes relational databases.
